(19) United States
(12) Patent Application Publication
(10) Pub. No.: US 2023/0342115 A1
(43) Pub. Date: Oct. 26, 2023

(54) METHOD FOR GENERATING SOURCE CODE

(71) Applicant: dSPACE GmbH, Paderborn (DE)

(72) Inventor: Sven Harder, Paderborn (DE)

(21) Appl. No.: 18/191,905

(22) Filed: Mar. 29, 2023

(30) Foreign Application Priority Data
Apr. 26, 2022 (EP) 22169925.9

(51) Int. Cl. G06F 8/30; G06F 8/41

(52) U.S. Cl. CPC G06F 8/30; G06F 8/447

(57) ABSTRACT

A method for generating source code from at least one hierarchical block of a block diagram includes: reading in a block diagram; replacing a reference by a referenced data object; determining at least one code generation setting on the basis of the referenced data object; generating an intermediate representation; performing at least one optimization on the intermediate representation; and translating the intermediate representation into source code.

### CROSS-REFERENCE TO PRIOR APPLICATIONS

Priority is claimed to European Patent Application No. EP 22169925.9, filed on Apr. 26, 2022, the entire disclosure of which is hereby incorporated by reference herein.

### FIELD

The invention relates to the generation of executable code from a block diagram, in particular for programming control devices.

### BACKGROUND

Control devices are used in a large number of applications in order to capture physical variables of a process and/or to act on a process via connected actuators; for example, an anti-lock control of a braking process. The time constants determining the dynamic behavior of the process frequently require cycle times of 1 ms or shorter, so that a real-time capability of the control device is generally required. For cost reasons, control devices often have microcontrollers with low memory and limited computing power, for which reason the size and efficiency of the executable code is critical.

In order to accelerate the design of control devices, control strategies on the basis of models in a computing environment such as MATLAB/Simulink are often developed. The process and/or controller or, in general, the behavior of the control device may thus be simulated first, and the presence of desired properties may be checked. In particular, the models may be block diagrams that contain blocks that perform operations, such as calculations, wherein a block can calculate an output signal from multiple input signals, for example. As a rule, block diagrams are executed cyclically, wherein all blocks are kept permanently in memory, and each block is executed once per time step. In particular, a block may apply one or more operations to at least one input signal from the last step in order to generate at least one output signal of the current step. From the models, source code for programming the control device can be generated directly via a code generator. For example, a code generator for generating production quality source code is described in the document entitled “Production Quality Code Generation from Simulink Block Diagrams,” Proceedings of the 1999 International Symposium on Computer Aided Control System Design, Kohala Coast, Hawaii, by H. Hanselmann et al. In this case, the production code generated can be adapted by an additional annotation of the blocks or block variables.

The AUTOSAR development partnership (AUTomotive Open System ARchitecture) has been defining a software framework for the development of control device software (detailed information is available at autosar.org) Before implementing the actual control strategy or the desired behavior, an architecture of the software is established. For example, the software architecture can correspond to the AUTOSAR Classic Platform standard version 4.3.0 of 30 Nov. 2016. The architecture comprises software components, sub-components, such as runnables and interfaces of software components. Messaging between different software components takes place via the virtual functional bus of a runtime environment (RTE), which is generated in a suitable manner for the specific control device on the basis of the defined architecture. Control device software generated in this way is efficient but inflexible—for an adaptation, the runtime environment would have to be generated afresh and the binary code stored in the control device.

As a result of the increasing networking of control devices in modern vehicles, the associated greater communication between the components involved and also the possibility of introducing new components via OTA (over-the-air) updates, new, flexible communication architectures are required for efficient communication in the vehicle. For this purpose, the AUTOSAR Adaptive Platform has been developed which on the basis of an operating system such as Linux offers middleware with modern interfaces. Through modern communication architectures, AUTOSAR Runtime for Adaptive Applications, defined for example in AUTOSAR Adaptive release 19.03 dated 29 Mar. 2019, supports highly dynamic communication in systems consisting of networked control devices. The functional cluster ara::com thus provides a service-based architecture in order to allow communication relationships which are created or defined only during the runtime of a control device.

In the case of larger development projects, different areas of development are frequently carried out by a plurality of people who may also work at different companies. This allows several functional developers to create and improve individual parts of the model. A sub-model once created can also be used for different projects and adapted in terms of its functionality. If a sub-model created for Classic AUTOSAR is to be used in the AUTOSAR Adaptive Platform, this will however require, according to the prior art, extensive adaptations, so that effectively two independent models to be maintained are created.

### SUMMARY

In an exemplary embodiment, the present invention provides a method for generating source code from at least one hierarchical block of a block diagram. A hierarchical block of the at least one hierarchical block comprises a plurality of subordinate blocks implementing calculations of the hierarchical block. The hierarchical block comprises at least one communication block that exchanges data with a block outside the hierarchical block. The at least one communication block is provided with a reference to a data object. The method comprises: reading in the block diagram; replacing the reference by the referenced data object; determining at least one code generation setting on the basis of the referenced data object; generating an intermediate representation; performing at least one optimization on the intermediate representation; and translating the intermediate representation into source code.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 depicts an example embodiment of a computer system;

FIG. 2 depicts a schematic representation of software components available on a computer system;

FIG. 3 depicts a schematic flowchart of an embodiment of a method according to the invention for generating source code;

FIG. 4 depicts a first example of a hierarchical block with multiple communication blocks;

FIG. 5 depicts a second example of a hierarchical block with multiple communication blocks; and

FIG. 6 depicts a preferred embodiment of a user interface for processing references.

### DETAILED DESCRIPTION

Exemplary embodiments of the present invention facilitate universal use of sub-models in various projects.

In an exemplary embodiment of the invention, a method for generating source code from at least one hierarchical block of a block diagram is provided, wherein a hierarchical block comprises a plurality of subordinate blocks implementing calculations of the hierarchical block, wherein the hierarchical block comprises at least one communication block that exchanges data with a block outside the hierarchical block, and wherein the at least one communication block is provided with a reference to a data object. The method comprises the steps of:
reading in the block diagram,
replacing the reference by the referenced data object,
determining at least one code generation setting on the basis of the referenced data object,
generating an intermediate representation,
performing at least one optimization on the intermediate representation, and
translating the intermediate representation into source code.

Data or signals may be transmitted via a signal connection; in so doing, a first block outputs one value or, depending on the definition, multiple related values, and a second block receives them and takes them into account when determining one or more related output values of the second block. Signals can contain scalar variables and/or structured data types such as arrays and structs, as is the case with a bus, for example. The communication block may be an input port or an output port; it may also be a block that models a memory variable or read or write access to a memory variable, such as a data store memory block or a data store write block or a data store read block.

A reference may be stored in the form of a block parameter of the respective block. The replacement of the reference can be configured as a resolution of the reference in order to obtain the referenced data object or can comprise even a resolution of the reference, in particular an access to a definition data collection. The determination of at least one code generation setting can include a validation of the model, wherein the code generation is terminated with an error message if at least one plausibility rule is violated. The code generation setting determined can comprise the specification of a data object to be used, such as a variable and/or a data type for a data object or a variable used in the code. As a result of the code generation setting, variables defined in the source code in particular can thus be adjusted; this can also influence the applicable optimizations.

If the hierarchical block comprises a plurality of communication blocks, it will be advantageous that each of the communication blocks is provided in each case with a reference to a data object. The hierarchical block or subsystem may comprise one or more input ports and one or more output ports. By assigning each of the blocks to a data object, the input and output may be adapted for the entire subsystem.

In a preferred embodiment of the invention, the data object is a placeholder which is defined after the code generation or generation of source code, in particular by a preprocessor macro. By defining the communication via a placeholder, an adjustment can be effected during incremental code generation without a fresh code generation being required. In this case, the reference makes it possible to use placeholders adapted to the code generation mode or target hardware.

The hierarchical block preferably comprises a function block, wherein a reference to a call modality is stored in the function block. The reference can point to a data object for defining a function signature, the object being stored in a definition data collection. The call modalities may comprise an order of the arguments and/or an indication of whether the respective argument is to be handed over via a copy of the value (CallByValue) or by a pointer (CallByReference).

Preferably, the hierarchical block comprises at least two input ports and/or at least two output ports, and the call modality comprises an order of the arguments and/or a combination of the at least two input ports and/or of the at least two output ports to form a structure in the generated source code. The reference to a call modality can take various forms, in particular a definition of a function signature with input argument(s), output argument(s) and return value.

In a preferred embodiment of the invention, the reference points to a first data object or a second data object depending on a mode, wherein replacing the reference by the first data object takes place when a first mode has been selected, or replacing the reference by the second data object takes place when a second mode has been selected. This enables variation of the references. Expediently, a data model of a definition data collection is defined such that variation of references can also take place in connection with a semantic and/or syntactic validation. The selection of a mode can be received, for example, via a user interface.

The mode preferably specifies a code generation modality, in particular standard code generation, Classic AUTOSAR code generation and/or Adaptive AUTOSAR code generation. Code generation modalities can differ with regard to external form specifications. For example, from a hierarchical block a function can be generated in the standard code generation, a runnable with explicit or implicit communication can be generated in Classic AUTOSAR code generation, and an adaptive application with use of services can be generated in Adaptive AUTOSAR code generation.

It is advantageous if the communication block can refer to more than one data object, in particular at least one reference comprises a port, a data element and/or a communication mode. For example, an output port can be implemented in the standard code generation via a global variable, while in Classic AUTOSAR code generation an explicit or implicit communication takes place via a runtime environment (RTE). For example, the references under Classic AUTOSAR can comprise a transmitter/receiver port and a data element; the communication mode can for example comprise writing via explicit or implicit communication over the RTE. It can also be provided that a reference is made to an access function. In Adaptive AUTOSAR code generation, the communication block may be implemented as access to a service.

The hierarchical block preferably comprises at least one calculation block which receives an input signal and calculates an output signal therefrom, wherein the calculation block is provided with a reference to a data object. The term ‘calculation’ may cover various operations that receive at least one input signal and generate at least one output signal therefrom. In this sense, for example, a delay of one time step as performed by a unit delay block can also represent a calculation. The calculation block can be, for example, a gain block which multiplies an input signal by a prespecified factor. In the case of a standard code generation, the factor can be prespecified via a variable or a constant; in the case of an AUTOSAR code generation, the factor can be accessed via an access function. In addition to a calibration or adjustment of the factor, the use of placeholders also makes it possible to log the current value.

The invention further relates to a method for configuring a control device, wherein the control device comprises at least one arithmetic unit and preferably has at least one sensor and/or at least one actuator for acquiring data of a physical process and/or acting thereupon, the method comprising the steps of
a. Reading a block diagram,
b. Generating source code with a method (e.g., according to a method discussed above),
c. Compiling the source code for the arithmetic unit so that an executable code is generated,
d. Transferring the executable code to the control device, and
e. Storing the executable code in a non-volatile memory of the control device and/or executing the executable code by the control device's arithmetic unit.

Furthermore, the invention relates to a computer program product with a computer-readable storage medium on which instructions are embedded that, if executed by a processor, cause the processor to be configured to execute a method according to the invention.

Further, the invention relates to a computer system comprising a human-machine interface, a non-volatile memory and a processor, wherein the processor is configured to execute a method according to the invention.

The invention is explained in more detail below with reference to the drawings. In doing so, similar parts are labeled with identical designations. The embodiments shown are schematic; that is, the distances and the lateral and vertical dimensions are not to scale and, unless otherwise indicated, do not have any derivable geometric relations relative to each other.

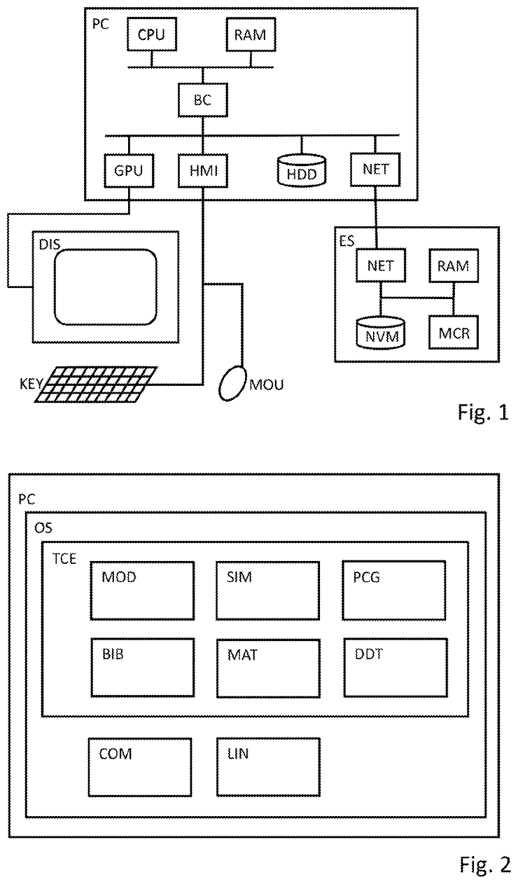

FIG. 1 shows an example embodiment of a computer system PC. This computer system has a processor CPU, which may be implemented as a multi-core processor in particular, a working memory RAM and a bus controller BC. Preferably, the computer system PC is designed to be operated directly manually by a user, wherein a monitor DIS is connected via a graphics card GPU, and a keyboard KEY and a mouse MOU are connected via a peripheral interface HMI. The human-machine interface of the computer system PC could also be configured as a touch interface. The computer system also includes a non-volatile data memory HDD which may be designed in particular as a hard disk and/or solid state disk, along with an interface NET, in particular a network interface. A control device ES may be connected via the interface NET. One or more arbitrary interfaces, in particular wired interfaces, can be present on the computer system PC and can each be used for the connection to a control device ES. Expediently, a network interface according to the Ethernet standard may be used; the interface NET may also be designed to be wireless, such as a WLAN interface in particular, or according to a standard such as Bluetooth.

The control device ES may be designed as a serial control device or as an evaluation board for a target platform. It is expedient to include an interface NET for connecting to the computer system PC, a microcontroller MCR with an architecture deviating from that of the processor of the computer system, a working memory RAM and a non-volatile memory NVM.

In an alternative embodiment, the computer system may comprise one or more servers comprising one or more computing elements such as processors or FPGAs, the servers being connected via a network to a client comprising a display device and input device. The method for generating source code can thus be executed partially or completely on a remote server, for example in a cloud computing setup. As an alternative to a PC client, a graphical user interface may be displayed on a portable computing device, in particular a tablet or a smartphone.

FIG. 2 shows a diagram of the software components preferably installed on the computer system PC. Such components use mechanisms of the operating system OS, for example to access the non-volatile memory HDD or to establish a connection to an external computer via the network interface NET.

A technical computing environment TCE enables the creation of models and the generation of source code from the models. In a modeling environment MOD, models of a dynamic system may preferably be created via a graphical user interface. In particular, these may be block diagrams that comprise multiple blocks and describe the temporal behavior and/or internal states of a dynamic system. At least some of the blocks are connected by signals; that is, directional connections for the exchange of data, which can be scalar or composite. Blocks can be atomic, i.e., from the perspective of the surrounding blocks form a unit in which all input signals must be present at the beginning of a computing step and all output signals are present at the end of a computing step. If block diagrams are hierarchical, a large number of blocks at a subordinate level can describe the structure of a block at a superordinate level. Hierarchical or composite blocks, even when atomic, may comprise a plurality of blocks in a subordinate level. Such composite or hierarchical blocks may in particular be subsystems; subsystems may have additional properties, such as implementation in a separate function and/or triggering execution of the subsystem via a dedicated signal. In subsystems, special blocks may be arranged to further specify the properties of the subsystem.

The computing environment TCE comprises one or more libraries BIB, from which blocks or modules may be selected for building a model. In a script environment MAT, instructions may be entered interactively or via a batch file in order to perform calculations or modify the model. The computing environment TCE also includes a simulation environment SIM which is configured to interpret or execute the block diagram in order to investigate the temporal behavior of the system. Such calculations are preferably performed with high accuracy floating-point numbers on one or more cores of the microprocessor CPU of the computer system.

With the help of a code generator PCG, source code may be generated from a created model, preferably in a programming language such as C. Additional information regarding the model, in particular regarding the block variables, is expediently stored in a definition data collection DDT. In this case, it is advantageous if code generation settings such as value ranges and/or scaling are assigned to the block variables in order to support a calculation of the model with fixed-point instructions. Desired properties of the source code, for example conformity to a standard such as MISRA, can also be stored as code generation settings in the definition data collection DDT.

Expediently, each block variable is assigned to a given variable type, and one or more desired properties, such as the permissibility of optimizations, such as a grouping of variables, is set. The code generator PCG preferably evaluates the code generation settings of the definition data collection DDT and takes them into account when generating the source code. The definition data collection DDT may have a tree structure or may be stored as a simple file in a memory of the computer system; alternatively, storing the definition data in a dedicated database system may be provided. The definition data collection DDT may have a program interface and/or import/export functions.

The computer system PC has a compiler COM and a linker LIN, which are expediently configured for generating binary files that may be executed on a control device ES and/or the computer system PC. A large number of compilers may be available, in particular cross-compilers for different target platforms, in order to support control devices or evaluation boards ES with different processor architectures.

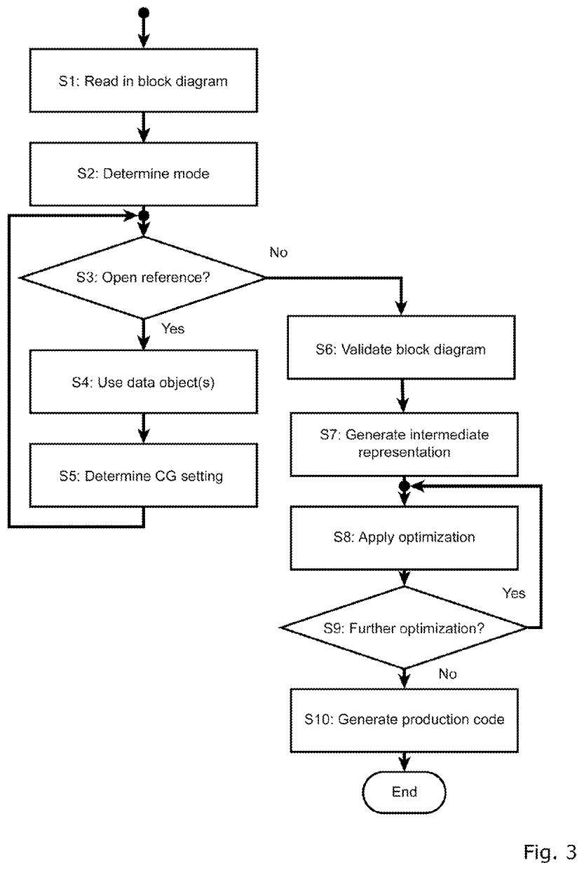

FIG. 3 shows a schematic flowchart of an embodiment of a method according to the invention for generating source code. The method may be executed entirely by a processor of a preferred embodiment of the computer system PC; however, it may also be executed in a client-server environment with an operating computer and one or more servers connected by a network, wherein in particular computationally intensive steps are expediently performed on the servers.

In Step S1 (Read in block diagram), a block diagram is read in. The block diagram comprises at least one hierarchical block and may include a plurality of further hierarchical blocks. The reading in of the block diagram expediently also comprises reading out from the definition data collection DDT at least one block property and/or settings relevant to code generation, such as, for example, the data type of a variable.

In Step S2 (Determine mode), a mode is determined which can preferably specify a code generation modality. The code generator can in particular support a standard code generation, a Classic AUTOSAR code generation and/or an Adaptive AUTOSAR code generation. Depending on the mode, source code with different properties is expediently generated in order to comply, in particular, with the conventions of various software environments such as an AUTOSAR runtime environment. In alternative embodiments of the invention, it can be provided as a further mode to generate code in a hardware description language, or a configuration of a programmable hardware module, from the block diagram.

In Step S3 (Open reference?), a check is made as to whether there are still unresolved references in the block diagram. For example, the hierarchical block may comprise a communication block provided with a reference to at least one data object. Depending on the mode determined, different data objects can be referenced. The number of referenced data objects can also vary depending on the mode. If there are still open or unresolved references, the data object(s) which are referenced by the current reference in the determined mode will be used in Step S4 (Use data object(s)). A code generation setting is then determined in Step S5 (Determine CG setting) on the basis of the at least one data object used. For example, the data object can be a variable whose data type is determined on the basis of a variable class assigned in the definition data collection.

As soon as there are no more open references, the block diagram is validated in Step S6 (Validate block diagram). Here it is possible to check for a plurality of prespecified conditions whether they have been fulfilled. For example, a check can be made in the hierarchical block as to whether it includes a port which does not yet have a signal connection. It can expediently be provided that the code generation is terminated with an error message if at least one of the prespecified conditions is not fulfilled. In particular the generation of incorrect codes due to obvious modeling errors is thus prevented.

In Step S7 (Generate intermediate representation), the selected model is transformed from one or more blocks of the block diagram BLD into an intermediate representation IR which preferably comprises one or more hierarchical graphs. In particular, this can be a data flow graph, a control flow graph or a tree structure. In addition to the block diagram BLD, it is expedient to also take additional information from a definition data collection DDT into account when generating the intermediate representation, or incorporate said information thereinto. This may also include situations in which elements based on information in the definition data collection DDT are generated.

In Step S8 (Apply optimization), the hierarchical graphs are optimized in order to reduce the number of variables required and/or memory consumption, such as stack allocation, and/or the number of operations and/or processor instructions and/or the execution time of the source code. Such optimization may comprise a large number of intermediate steps in which further intermediate representations between the model/block diagram and source code/program text are generated. In particular, it may be provided that, in each intermediate step, a set of original hierarchical graphs is converted into a different set of modified hierarchical graphs, wherein one or more optimization rules are applied. The optimization rules to be applied can be stored in the definition data collection and/or follow a preset standard order.

In Step S9 (Further optimization?), a check is made as to whether a further optimization rule is to be applied. In the optimization, various strategies or optimization rules such as “constant folding” or an elimination of “dead code” can be applied. If at least one optimization rule has not yet been applied or is to be applied once more, Step S8 will be repeated. Otherwise, the execution is continued in Step S10. It may also be provided that individual optimizations are to be applied already within the framework of the transformation in Step S7, in particular if they can be performed more easily on a block diagram representation. Within the framework of the invention, it is possible that multiple variables generated in Step S7 are combined in Step S8, and also that multiple variables of the block diagram are combined in Step S7 in such a way that the first intermediate representation now contains only one variable.

In Step S10 (Generate production code), the optimized intermediate representation IR or the optimized hierarchical graphs, which result from the entirety of the intermediate steps performed, are translated into source code PCO of a textual programming language, such as, in particular, C code. Moreover, an additional optimization may be carried out in this step, in particular in such a manner that the generated instructions represent a subset of the instructions that are included by the language, and/or that the generated control structures represent a subset of the control structures that are included by the language. This makes it possible to fulfill precisely defined rules. As an alternative or in addition, it may be provided for additional information to be generated, such as a reference between the program line and the block of the block diagram BLD, and in particular for it to be incorporated into the source code in the form of comments in order to improve the readability of the source code PCO and/or to simplify debugging.

During or after code generation, information regarding the current block diagram or results of code generation, such as warnings, may be stored in the definition data collection. This information may be used, for example, to influence a compilation of the generated source code or to provide meta-information for other tools, such as calibration information in the ASAP2 format or information for generating an intermediate layer for a runtime environment according to the AUTOSAR standard.

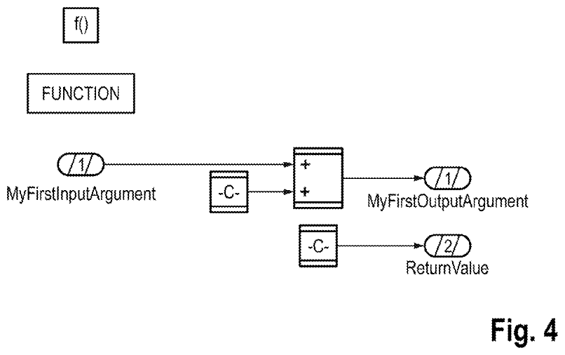

FIG. 4 illustrates a first example of a hierarchical block with multiple communication blocks, the subordinate blocks being depicted which implement the functionality of the hierarchical block. A first communication block, an input port, receives a MyFirstlnputArgument signal. In a summation block a constant value C is added to the input signal. A second communication block, an output port, outputs the resulting total value as the MyFirstOutputArgument signal. A constant value is output as ReturnValue signal via a third communication block, a further output port. Via a function block, FUNCTION, properties of the hierarchical block can be set; the properties may vary depending on the mode. The properties can comprise a number and order of arguments as well as call modalities such as CallByValue or CallByReference, that is to say the generation of a copy of the respective argument or the transfer of a pointer to the respective argument.

For example, for the standard code generation mode, the generation of a MyServerFunction function can be selected, which has two arguments, has a scalar input value and a pointer to a scalar output value, and has a scalar return value. Different variable classes can be selected for the arguments, so that the corresponding variables can have different data types and can be arranged in different memory areas. A scaling can also be specified for the respective argument. Listing 1 shows the source code generated from the hierarchical block of FIG. 4 in a standard code generation mode:

const UInt8 FUNCTION_RESULT_NOT_OK = 1;
const UInt8 FUNCTION_RESULT_OK = 0;
MyFirstSimpleType MyFirstNvDataVar = 224;
MyFirstSimpleType MyFirstCalVar = 100;
UInt8 MyServerFunction(MyFirstSimpleType MyInputArg,
MyFirstSimpleType * MyOutputArg) {
/* Outport: MyFirstOutputArgument */
*MyOutputArg = (Int32) (MyInputArg + MyFirstCalVar);
/* Outport: ReturnValue */
return FUNCTION_RESULT_OK;
}
Listing 1: Generated server function

For Classic AUTOSAR code generation mode, the generation of a server runnable can be set with the corresponding arguments. The order of the arguments, the data type, or even the call modality of one or more arguments can be set for this mode in a different way from the standard mode. Listing 2 shows the source code generated from the hierarchical block of FIG. 4 in a Classic AUTOSAR code generation mode:

FUNC(Std_ReturnType, MySwc_CODE)
MyFirstServerRunnable(MyFirstSimpleType MyFirstInputArgument,
P2VAR(MyFirstSimpleType, AUTOMATIC, RTE_APPL_DATA)
MyFirstOutputArgument) {
Std_ReturnType Sa1_ReturnValue;
/* Outport: ReturnValue */
Sa1_ReturnValue = RTE_E_OK;
/* Outport: MyFirstOutputArgument */
*MyFirstOutputArgument = (sint32) (MyFirstInputArgument +
Rte_CData_MyFirstSharedCalPrmVariable( ));
return Sa1_ReturnValue;
}
Listing 2: Generated server-runnable

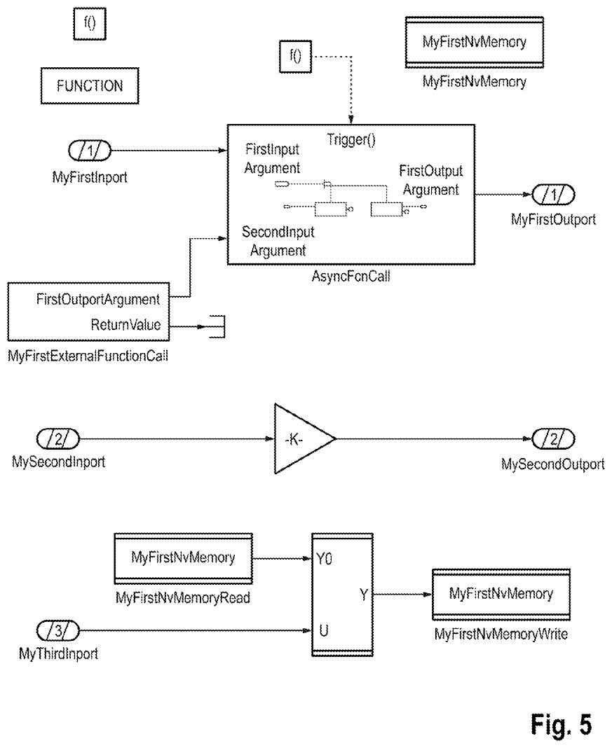

FIG. 5 illustrates a second example of a hierarchical block with multiple communication blocks, wherein the subordinate blocks are depicted which implement the functionality of the hierarchical block or subsystem.

Via three input ports, MyFirstInport, MySecondInport, and MyThirdInport, input signals can be received from the outside. Furthermore, the subsystem has a memory variable MyFirstNvMemory, which is accessed via the read block MyFirstNvMemoryRead and the write block MyFirstNvMemoryWrite. The calculated output signals are output via two output ports, MyFirstOutport and MySecondOutport. The subsystem further comprises a call of an external function, MyFirstExternalFunctionCall, which supplies an output signal and a return value. The output signal serves as input signal SecondInputArgument of a subordinate subsystem Async_Fcn_Call. This subsystem is cyclically triggered by a function call generator. The second output signal MySecondOutport is calculated from the second input signal via a multiplication block K. The third input signal MyThirdInport is assigned via an assignment block to the data storage variables.

Via a function block FUNCTION, the order of the arguments, the data type or even the call modality of one or more arguments can be adapted. It can also be provided for several arguments to be combined into one structure and for only this to be transferred. Listing 3 shows the source code generated from the hierarchical block of FIG. 5 in a standard code generation mode:

typedef Int32 MyFirstSimpleType;
typedef UInt8 MySecondSimpleType;
struct tag_MyInput {
MyFirstSimpleType a;
MyFirstSimpleType b;
MySecondSimpleType c;
}; /* struct type for variable: MyInput */
void MyMainFunction(MyFirstSimpleType * FirstOutput,
MyFirstSimpleType * SecondOutput, struct tag_MyInput *
MyInput) {
UInt8 MyReturnStatus;
UInt8 CallStatus_a;
UInt8 ResultsStatus_a;
static MyFirstSimpleType MyOutputArg_b;
/* Outport: MySecondOutport, update variable of MySecondInport
*/
*SecondOutput =(Int32) ((((Int16)MyInput−
>b) * ((Int16)MyFirstCalVar))>>2);
/* call of function: MyFirstExternalFunctionCall */
MyReturnStatus = MyExternalFunction(&MyOutputArg_b);
/* update(s) for inport FirstInputArgument, variable of
MyFirstInport */
SAsyncExtFcnCall1_FirstInputArgument = (Int16) (MyInput−>a >>
2);
/* update(s) for inport SecondInputArgument */
SAsyncExtFcnCall1_SecondInputArgument = (Int16) (MyOutputArg_b
>> 2);
/* call of function: MyFirstAsynchronousServerCallPoint */
CallStatus_a = MyFirstAsyncExternalFunctionCall ( );
/* call of function: MyFirstAsynchronousServerCallResultPoint,
Outport: MyFirstOutport */
MyFirstAsyncExternalFunctionResult(FirstOutput,
&ResultStatus_a);
/* Data store write: MyFirstNvMemoryWrite */
MyFirstNvDataVar = (Int32) (((UInt32) MyInput−>c) << 2);
}
Listing 3: Generated cyclic function

By defining the tag_My_Input data type, several variables can be transferred via a common structure.

Listing 4 shows the source code generated from the hierarchical block of FIG. 5 in a Classic AUTOSAR code generation mode:

```
FUNC(void, MySwc_CODE) MyFirstRunnable(void) {
MyFirstSimpleType FirstDataElement_a;
MyFirstSimpleType FirstNvDataElement;
MyFirstSimpleType MyFirstOutputArgument_a;
Std_ReturnType Sa1_Return_Value;
MyFirstSimpleType MyFirstOutputArgument_b;
Std_ReturnType Sa1_Return_Value_a;
Std_ReturnType Sa1_Return_Value_b;
/* Outport: MySecondOutport, Inport: MySecondInport */
Rte_IrvWrite_MyFirstRunnable_MyFirstInterRunnableVariable((sin
t32) ((((sint16)
Rte_IrvRead_MyFirstRunnable_MyFirstInterRunnableVariable( ))*
  ((sint16) Rte_CData_MyFirstSharedCalPrmVariable( ))) >>
  2));
/* Inport: MyFirstInport */
Rte_Read_MyFirstReceiverPort_FirstDataElement(&FirstDataElemen
t_a);
/* call of function: MyFirstExternalFunctionCall */
Sa1_Return_Value = Rte_Call_MyFirstClientPort_MyFirstOperation
  (&MyFirstOutputArgument_a);
/* call of function: MyFirstAsynchronousServerCallPoint */
Sa1_Return_Value_a =
Rte_Call_MyFirstClientPort_MySecondOperation
  (FirstDataElement_a, MyFirstOutputArgument_a);
/* call of function: MyFirstAsynchronousServerCallResultPoint
*/
Sa1_Return_Value_b =
Rte_Result_MyFirstClientPort_MySecondOperation
  (&MyFirstOutputArgument_b);
/* Outport: MyFirstOutport */
Rte_Write_MyFirstSenderPort_FirstDataElement(MyFirstOutputArgu
ment_b);
/* Data store read: MyFirstNvMemoryRead */
Rte_Read_MyFirstNvSenderReceiverPort_FirstNvDataElement
  (&FirstNvDataElement);
/* Data store write: MyFirstNvMemoryWrite, Inport:
MyThirdInport */
Rte_Write_MyFirstNvSenderReceiverPort_FirstNvDataElement((sint
32)
  (((uint32)Rte_Mode_MyFirstModeReceiverPort_FirstModeEle
  ment( ))
  << 2));
}
Listing 4: Generated runnable
```

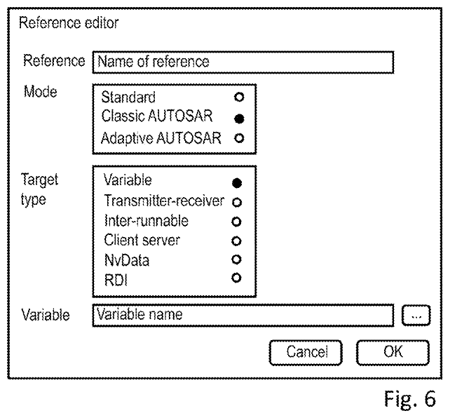

FIG. 6 shows a preferred embodiment of a user interface for processing references. The reference editor window can be opened in particular via the context menu of a communication block.

In a Reference field, the user can specify a name of the reference to be processed. The name of the reference can also include the names of superordinate subsystems or hierarchical blocks if the corresponding communication block is located in a subordinate hierarchy level of the block diagram. In the other fields, properties of the specified reference can be adapted by the user. Since the properties can vary depending on the code generation mode, the user expediently specifies in the Mode field the code generation mode for which the reference is to be processed. A list with three elements, Standard, Classic AUTOSAR and Adaptive AUTOSAR, is shown, wherein Classic AUTOSAR mode is selected. Various well-known control elements, such as a drop-down list or checkboxes, can be used for the selection.

In a Target type field, the user can select various types of references which also differ in the number of referenced data objects. The list shown comprises six elements: Variable, Transmitter-receiver, Inter-runnable, Client-server, NvData and RDI. It can be provided that the selectable elements of the list are dependent on the mode specified. A reference of the Variable type can reference a variable and thus indirectly also its associated data type. This reference can be used universally and can also be referenced in calculation blocks. As a result, it is possible, in particular, to log, i.e., to record, the time-dependent variable values of a block variable of the calculation block, or to calibrate the block variable, i.e., to change its value. A reference of the Transmitter-receiver type makes it possible to specify, at an input or output port, a transmitter-receiver communication customary under Classic AUTOSAR and comprises a plurality of data objects. A reference of the Inter-runnable type makes it possible under Classic AUTOSAR to specify a data exchange via an inter-runnable variable. A reference of the Client-server type makes it possible to specify, at an input or output port, a client-server communication customary under Classic AUTOSAR and comprises a plurality of data objects. A reference of the NvData type may specify writing to a non-volatile flash memory. A reference of the RDI type represents a placeholder which, after code generation, is defined in particular by a pre-processor macro. In addition to the types of references mentioned by way of example, further types can also be offered or edited in the user interface. For the selection of a type, various well-known control elements, such as a drop-down list or checkboxes, can be used.

In the illustrated user interface, a reference of the Variable type is selected. For this reason, a Variable field in which a variable name can be specified is displayed below the list of types. In addition to a text box, various well-known control elements can be used. If a different type of reference is selected, the field(s) relevant for this type are expediently displayed.

After the properties of the reference have been received by the user, the computer system expediently stores them in a definition data collection assigned to the block diagram. In this way the changes can be taken into account in the next code generation.

A method according to the invention makes it possible to model universal hierarchical blocks for which adapted code is generated depending on the code generation mode. A large number of different types of data exchange are supported here, be it communication via a runtime environment or the use of a variable. This increases the reusability of hierarchical blocks once created and thus accelerates the development of control devices.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for generating source code from at least one hierarchical block of a block diagram, wherein a hierarchical block of the at least one hierarchical block comprises a plurality of subordinate blocks implementing calculations of the hierarchical block, wherein the hierarchical block comprises at least one communication block that exchanges data with a block outside the hierarchical block, wherein the at least one communication block is provided with a reference to a data object, and wherein the method comprises:
reading in the block diagram;
replacing the reference by the referenced data object;
determining at least one code generation setting on the basis of the referenced data object;
generating an intermediate representation;
performing at least one optimization on the intermediate representation; and
translating the intermediate representation into source code.

2. The method according to claim 1, wherein the hierarchical block comprises a plurality of communication blocks, and wherein each of the respective communication blocks is provided with a respective reference to a respective data object.

3. The method according to claim 1, wherein the data object is a placeholder to be defined after the generation of source code.

4. The method according to claim 3, wherein the placeholder is defined by a pre-processor macro.

5. The method according to claim 1, wherein the hierarchical block comprises a function block, wherein a reference to a call modality is stored in the function block.

6. The method according to claim 5, wherein the hierarchical block comprises at least two input ports and/or at least two output ports, and wherein the call modality comprises an order of arguments and/or a combination of the at least two input ports and/or of the at least two output ports to form a structure in the generated source code.

7. The method according to claim 1, wherein the reference points to a first data object or a second data object depending on a mode; and
wherein replacing the reference by the referenced data object comprises:
replacing the reference by the first data object based on a first mode having been selected; or
replacing the reference with the second data object based on a second mode having been selected.

8. The method according to claim 7, wherein the mode indicates a code generation modality.

9. The method according to claim 8, wherein the mode indicating the code generation modality comprises the mode indicating standard code generation, Classic AUTOSAR code generation, and/or Adaptive AUTOSAR code generation.

10. The method according to claim 1, wherein the at least one communication block refers to more than one data object.

11. The method according to claim 10, wherein the at least one communication block refers to at least one reference comprising a port, a data element, and/or a communication mode.

12. The method according to claim 1, wherein the hierarchical block comprises at least one calculation block that receives an input signal and calculates an output signal therefrom, and wherein the calculation block is provided with the reference to the data object.

13. The method according to claim 1, further comprising:
compiling the source code for an arithmetic unit of a control device such that an executable code is generated;
transferring the executable code to the control device; and
storing the executable code in a non-volatile memory of the control device and/or executing, by the arithmetic unit, the executable code.

14. The method according to claim 13, wherein the control device comprises at least one sensor and/or at least one actuator for acquiring data from and/or acting upon a physical process.

15. A non-transitory computer-readable medium having processor-executable instructions stored thereon for generating source code from at least one hierarchical block of a block diagram, wherein a hierarchical block of the at least one hierarchical block comprises a plurality of subordinate blocks implementing calculations of the hierarchical block, wherein the hierarchical block comprises at least one communication block that exchanges data with a block outside the hierarchical block, wherein the at least one communication block is provided with a reference to a data object, and wherein the processor-executable instructions, when executed, facilitate:
reading in the block diagram;
replacing the reference by the referenced data object;
determining at least one code generation setting on the basis of the referenced data object;
generating an intermediate representation;
performing at least one optimization on the intermediate representation; and
translating the intermediate representation into source code.

16. A computer system, comprising:
a non-volatile memory having instructions stored thereon; and
a processor configured to execute the instructions to a method for generating source code from at least one hierarchical block of a block diagram being performed by the computer system, wherein a hierarchical block of the at least one hierarchical block comprises a plurality of subordinate blocks implementing calculations of the hierarchical block, wherein the hierarchical block comprises at least one communication block that exchanges data with a block outside the hierarchical block, wherein the at least one communication block is provided with a reference to a data object, and wherein the method comprises:
reading in the block diagram;
replacing the reference by the referenced data object;
determining at least one code generation setting on the basis of the referenced data object;
generating an intermediate representation;
performing at least one optimization on the intermediate representation; and
translating the intermediate representation into source code.
